(19) United States
(12) Patent Application Publication
(10) Pub. No.: US 2024/0129730 A1
(43) Pub. Date: Apr. 18, 2024

(54) Authentication Indication for Edge Data Network Relocation

(71) Applicant: Apple Inc., Cupertino, CA (US)

(72) Inventors: Shu GUO, Beijing (CN); Dawei ZHANG, Saratoga, CA (US); Haijing HU, Los Gatos, CA (US); Huarui LIANG, Beijing (CN); Mona AGNEL, Guildford (GB); Ralf ROSSBACH, Munich (DE); Robert ZAUS, Munich (DE); Sudeep MANITHARA VAMANAN, Uttenreuth (DE)

(21) Appl. No.: 18/546,804

(22) PCT Filed: Feb. 19, 2021
(86) PCT No.: PCT/CN2021/076952

§ 371 Date: Aug. 17, 2023

(51) Int. Cl. H04W 12/06; H04W 12/37

(52) U.S. Cl. CPC H04W 12/06; H04W 12/37

(57) ABSTRACT

A user equipment (UE) configured to connect to an edge data network. The UE connects to a first edge application server (EAS) of an edge data network (EDN), the connecting comprising performing a first authorization/authentication procedure, receives a message indicating the UE is to connect to a second EAS of the EDN, the message including an indication as to whether the UE is to perform a second authorization/authentication procedure to connect to the second EAS and performs a discovery procedure to locate the second EAS based on at least the indication in the message.

### TECHNICAL FIELD

This application relates generally to wireless communication systems, and in particular relates to authentication indication for edge data network relocation.

### BACKGROUND

A user equipment (UE) may connect to an edge data network to access edge computing services. Edge computing refers to performing computing and data processing at the network where the data is generated. To establish a connection with the edge data network, the UE may have to perform an authentication procedure with an edge configuration server (ECS).

As the UE changes location, the network may determine that a new path should be used for the UE to access the edge computing services. Since the UE is now accessing the edge computing services using a new path, an issue has arisen as to whether the UE should perform a new authentication procedure with the ECS.

### SUMMARY

Some exemplary embodiments are related to a processor of a user equipment (UE) configured to perform operations. The operations include connecting to a first edge application server (EAS) of an edge data network (EDN), the connecting comprising performing a first authorization/authentication procedure, receiving a message indicating the UE is to connect to a second EAS of the EDN, the message including an indication as to whether the UE is to perform a second authorization/authentication procedure to connect to the second EAS and performing a discovery procedure to locate the second EAS based on at least the indication in the message.

Other exemplary embodiments are related to a processor of a network component configured to perform operations. The operations include determining that a connection between a user equipment (UE) and a first edge application server (EAS) of an edge data network (EDN) should be switched to a connection between the UE and a second EAS of the EDN and sending a message to the UE indicating the UE is to connect to the second EAS, the message including an indication as to whether the UE is to perform a second authorization/authentication procedure to connect to the second EAS.

Still further exemplary embodiments are related to a user equipment (UE) having a processor and a transceiver communicatively connected to the processor. The processor is configured to perform operations including connecting to a first edge application server (EAS) of an edge data network (EDN), the connecting comprising performing a first authorization/authentication procedure, receiving a message indicating the UE is to connect to a second EAS of the EDN, the message including an indication as to whether the UE is to perform a second authorization/authentication procedure to connect to the second EAS and performing a discovery procedure to locate the second EAS based on at least the indication in the message.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an architecture for enabling edge applications according to various exemplary embodiments.

FIG. 4 shows a signaling diagram for a relocation procedure according to various exemplary embodiments.

### DETAILED DESCRIPTION

The exemplary embodiments may be further understood with reference to the following description and the related appended drawings, wherein like elements are provided with the same reference numerals. The exemplary embodiments relate to implementing an indication as to whether a user equipment (UE) should perform an authentication procedure for access to an edge data network when a location of the UE changes and results in a new path to the edge data network.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

Throughout this description, the terms “authorization,” “authentication,” and “authorization/authentication” are used interchangeably to describe a procedure or operation between the UE and the edge data network to verify the UE is allowed to access the edge data network. This procedure or operation is not limited to any particular procedure or operation but may encompass any procedure or operation that is used by an edge data network or a cellular core network to allow the UE to access the edge data network.

In addition, the exemplary embodiments are described with regard to a 5G New Radio (NR) network. However, reference to a 5G NR network is merely provided for illustrative purposes. The exemplary embodiments may be utilized with any network that implements the functionalities described herein for edge computing. Therefore, the 5G NR network as described herein may represent any network that includes the functionalities associated with edge computing.

The UE may access an edge data network via a 5G NR network. The edge data network may provide the UE with access to edge computing services. Edge computing refers to performing computing and data processing at the network where the data is generated. In contrast to legacy approaches that utilize a centralized architecture, edge computing is a distributed approach where data processing is localized towards the network edge, closer to the end user. This allows performance to be optimized and latency to be minimized.

The exemplary embodiments are further described with regard to an edge configuration server (ECS). The ECS may perform operations related to the authentication and authorization procedure for access to an edge data network. However, reference to an ECS is merely provided for illustrative purposes. The exemplary embodiments may be utilized with any electronic component that is configured with the hardware, software, firmware and/or cloud computing functionality to exchange information with the UE. Therefore, the ECS as described herein is used to represent any appropriate electronic component.

While the UE is connected to the edge data network, it may be determined that the current path used for application data traffic between the UE and the edge data network should be switched. The reason for the path switch may be, for example, the location of the UE has changed, there is congestion within the current path, etc. The specific reason for the path switch is outside the scope of this disclosure as the exemplary embodiments may be applied to any reason for the path switch. The exemplary embodiments relate to a relocation procedure for the UE when the path switch is being performed. While the exemplary embodiments user the term “relocation procedure,” as described above the reason for the path switch may include other reasons in addition to a physical relocation of the UE. Thus, the term “relocation procedure” is not limited to path switches based on a physical relocation of the UE, but any reason for a path switch. The exemplary embodiments of the relocation procedure include sending an indication to the UE as to whether a new authentication with the edge data network is used when performing the relocation procedure.

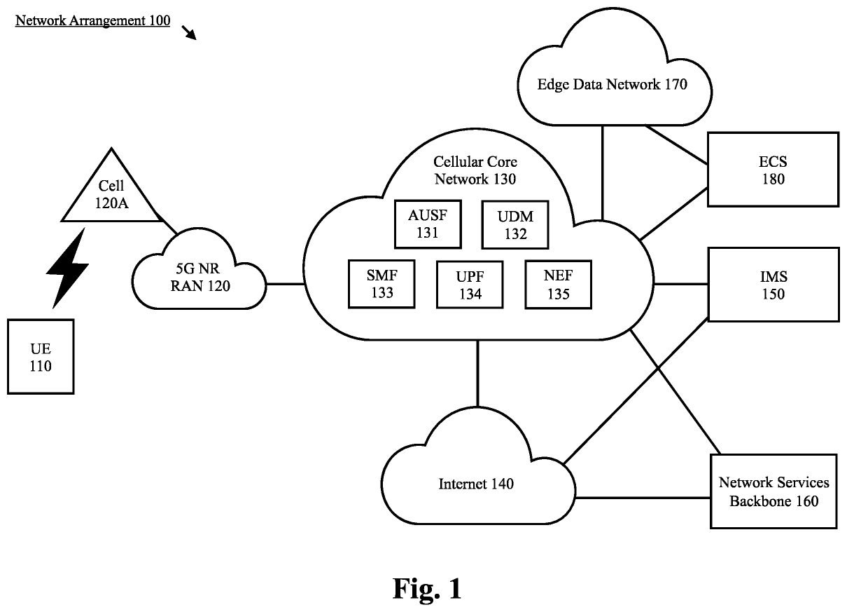

FIG. 1 shows an exemplary network arrangement 100 according to various exemplary embodiments. The exemplary network arrangement 100 includes UE 110. Those skilled in the art will understand that the UE 110 may be any type of electronic component that is configured to communicate via a network, e.g., mobile phones, tablet computers, desktop computers, smartphones, phablets, embedded devices, wearables, Cat-M devices, Cat-M1 devices, MTC devices, eMTC devices, other types of Internet of Things (IoT) devices, etc. An actual network arrangement may include any number of UEs being used by any number of users. Thus, the example of a single UE 110 is only provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g. 5G cloud RAN, an LTE RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In network arrangement 100, the 5G NR RAN 120 includes a cell 120A that represents a gNB. However, an actual network arrangement may include any number of different types of cells being deployed by any number of RANs. Thus, the example of a single cell 120A is merely provided for illustrative purposes.

The UE 110 may connect to the 5G NR-RAN 120 via the cell 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific cell (e.g., the cells 120A). However, as mentioned above, reference to the 5G NR-RAN 120 is merely for illustrative purposes and any appropriate type of RAN may be used.

The network arrangement 100 also includes a cellular core network 130. The cellular core network 130 may be considered to be the interconnected set of components or functions that manage the operation and traffic of the cellular network. In this example, the components include an authentication server function (AUSF) 131, a unified data management (UDM) 132, a session management function (SMF) 133, a user plane function (UPF) 134 and network exposure function (NEF) 135. However, an actual cellular core network may include various other components performing any of a variety of different functions.

The AUSF 131 may store data for authentication of UEs and handle authentication-related functionality. The AUSF 131 may be equipped with one or more communication interfaces to communicate with other network components (e.g., network functions, RANs, UEs, etc.). The exemplary embodiments are not limited to a AUSF that performs the above reference operations. Those skilled in the art will understand the variety of different types of operations a AUSF may perform. Further, reference to a single AUSF 131 is merely for illustrative purposes, an actual network arrangement may include any appropriate number of AUSFs.

The UDM 132 may perform operations related to handling subscription-related information to support the network's handling of communication sessions. The UDM 132 may be equipped with one or more communication interfaces to communicate with other network components (e.g., network functions, RANs, UEs, etc.). The exemplary embodiments are not limited to an UDM that performs the above reference operations. Those skilled in the art will understand the variety of different types of operations a UDM may perform. Further, reference to a single UDM 132 is merely for illustrative purposes, an actual network arrangement may include any appropriate number of UDMs.

The SMF 133 performs operations related to session management such as, but not limited to, session establishment, session release, IP address allocation, policy and quality of service (QoS) enforcement, etc. The SMF 133 may be equipped with one or more communication interfaces to communicate with other network components (e.g., network functions, RANs, UEs, etc.). The exemplary embodiments are not limited to an SMF that performs the above reference operations. Those skilled in the art will understand the variety of different types of operations a SMF may perform. Further, reference to a single SMF 133 is merely for illustrative purposes, an actual network arrangement may include any appropriate number of SMFs.

The UPF 134 performs operations related packet data unit (PDU) session management. For example, the UPF 134 may facilitate a connection between the UE 110 and the edge data network 170. The UPF 134 may be equipped with one or more communication interfaces to communicate with other networks and/or network components (e.g., network functions, RANs, UEs, etc.). More specifically, the UPF 134 may perform packet routing and forwarding when performing the role of an Uplink Classifier (UL-CL). The UL-CL may direct packet flows to specific data networks (e.g., one or more edge data networks as will be described in greater detail below). The UPF 134 may also perform the function of a PDU session anchor (PSA) that terminates the N6 interface of a PDU session within a 5G core network. The PSA provides mobility for a UE PDU session within a radio access technology (RAT), (e.g., within the NR-RAN 120) and between different RATs (e.g., between the NR-RAN 120 and other RATs such as LTE). The exemplary embodiments are not limited to an UPF that performs the above reference operations. Those skilled in the art will understand the variety of different types of operations an UPF may perform. Further, reference to a single UPF 134 is merely for illustrative purposes, an actual network arrangement may include any appropriate number of UPFs.

The NEF 135 is generally responsible for securely exposing the services and capabilities provided by 5G NR-RAN 120 network functions. The NEF 135 may be equipped with one or more communication interfaces to communicate with other network components (e.g., network functions, RANs, UEs, etc.). The exemplary embodiments are not limited to a NEF that performs the above reference operations. Those skilled in the art will understand the variety of different types of operations a NEF may perform. Further, reference to a single NEF 135 is merely for illustrative purposes, an actual network arrangement may include any appropriate number of NEFs.

While each of the AUSF 131, the UDM 132, the SMF 133, the UPF 134 and the NEF 135 may perform various functions with respect to the UE 110 connecting to an edge data network, the exemplary embodiments focus on the actions performed by the SMF 133 and the UPF 134 as these network functions are implicated in the relocation of the UE 110 with respect to the edge data network.

The network arrangement 100 also includes the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

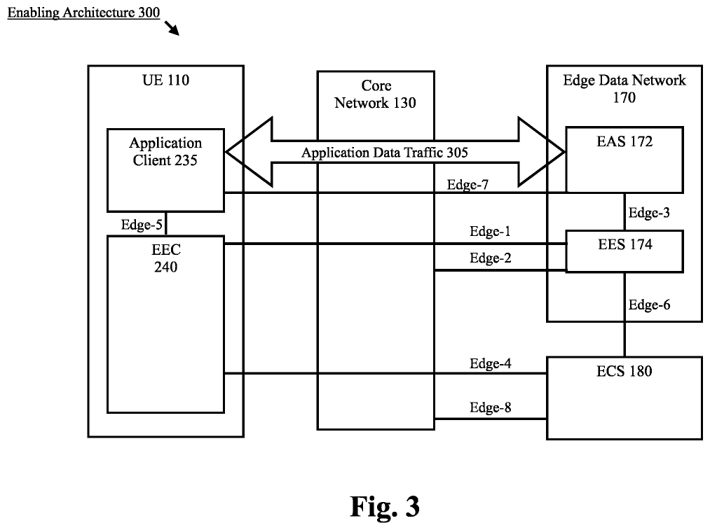

In addition, the network arrangement 100 includes an edge data network 170 and an edge configuration server (ECS) 180. The exemplary embodiments are described with regard to implementing an authentication and authorization procedure between the UE 110 and the ECS 180. The edge data network 170 and an ECS 180 will be described in more detail below with regard to FIG. 3.

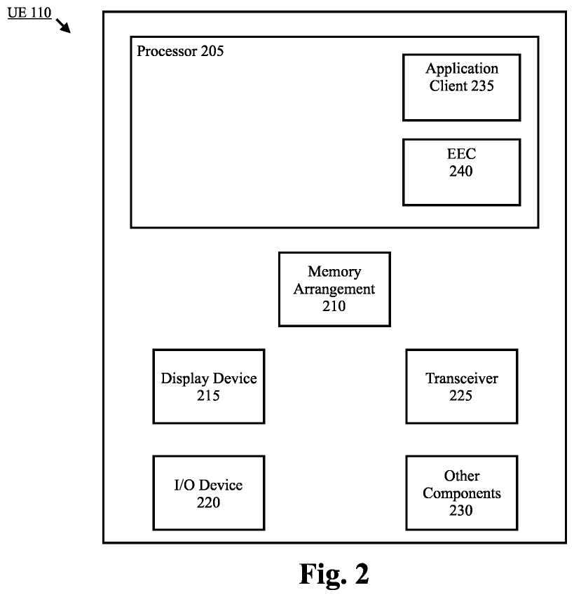

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 235 may include, for example, an audio input device, an audio output device, a power supply, a data acquisition device, ports to electrically connect the UE 110 to other electronic devices, etc.

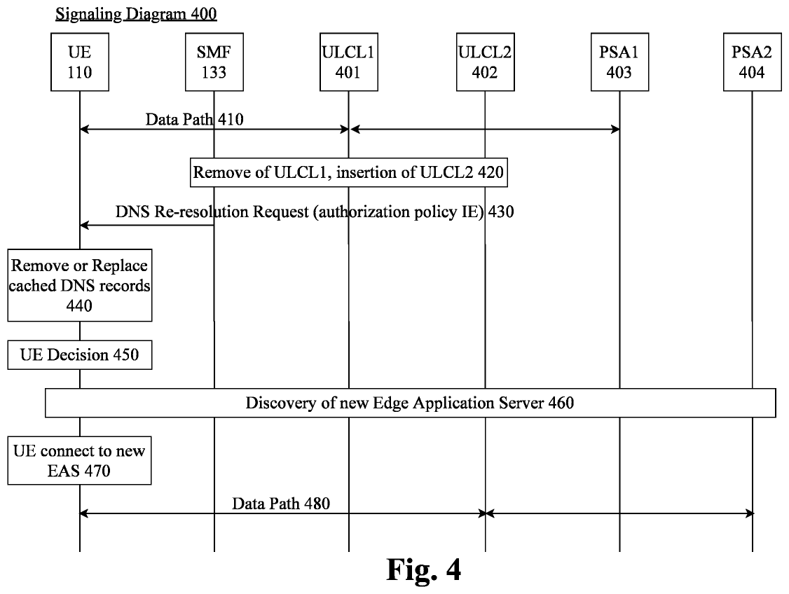

The processor 205 may be configured to execute various types of software. For example, the processor may execute an application client 235 and an edge enabler client (EEC) 240. The application client 235 may perform operations related to an application running on the UE 110 exchanging application data with a server via a network. The EEC 240 may perform operations related to establishing a connection to the edge data network 170. The application client 235 and the EEC 240 are discussed in more detail below with regard to FIG. 4.

The above referenced software being executed by the processor 205 is only exemplary. The functionality associated with the software may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

FIG. 3 shows an architecture 300 for enabling edge applications according to various exemplary embodiments. The architecture 200 will be described with regard to the network arrangement 100 of FIG. 1.

The exemplary embodiments will be described with regard to a relocation procedure between the EEC 240 of the UE 110 and the core network 130. When the relocation procedure uses authentication, the relocation procedure further includes interaction between the EEC 240 of the UE 110 and the ECS 180. The architecture 300 provides a general example of the type of components that may interact with one another when the UE 110 is configured to exchange application data traffic with the edge data network 170. A specific example of the exemplary relocation procedure will be provided below with regard to the signaling diagram 400 of FIG. 4.

The architecture 300 includes the UE 110, the core network 130 and the edge data network 170. The UE 110 may establish a connection to the edge data network 170 via the core network 130 and various other components (e.g., cell 120A, the 5G NR RAN 120, network functions, etc.).

In the architecture 300, the various components are shown as being connected via reference points labeled edge-x (e.g., edge-1, edge-2, edge-3, edge-4, edge-5, edge-6, edge-7, edge-8, etc.). Those skilled in the art will understand that each of these reference points (e.g., connections, interfaces, etc.) are defined in the 3GPP Specifications. The exemplary architecture arrangement 300 is using these reference points in the manner in which they are defined in the 3GPP Specifications. Furthermore, while these interfaces are termed reference points throughout this description, it should be understood that these interfaces are not required to be direct wired or wireless connections, e.g., the interfaces may communicate via intervening hardware and/or software components. To provide an example, the UE 110 exchanges communications with the gNB 120A. However, in the architecture 300 the UE 110 is shown as having a connection to the ECS 180. However, this connection is not a direct communication link between the UE 110 and the ECS 180. Instead, this is a connection that is facilitated by intervening hardware and software components. Thus, throughout this description the terms “connection,” “reference point” and “interface” may be used interchangeably to describe the interfaces between the various components in the architecture 300 and the network arrangement 100.

During operation, application data traffic 305 may flow between the application client 235 running on the UE 110 and the edge application server (EAS) 172 of the edge data network 170. The EAS 172 may be accessed through the core network 130 via uplink classifiers (CL) and branching points (NP) or in any other appropriate manner. Those skilled in the art will understand the variety of different types of operations and configurations relevant to an application client and an EAS. The operations performed by these components are beyond the scope of the exemplary embodiments. Instead, these components are included in the description of the architecture 300 to demonstrate that the exemplary authentication and authorization procedure between the UE 110 and the ECS 180 may precede the flow of application data traffic 305 between the UE 110 and the edge data network 170.

The EEC 240 may be configured to provide supporting functions for the application client 235. For example, the EEC 240 may perform operations related to concepts such as, but not limited to, the discovery of EASs that are available in an edge data network (e.g., EAS 172) and the retrieval and provisioning of configuration information that may enable the exchange of the application data traffic 305 between the application client 235 and the EAS 172. To differentiate the EEC 240 from other EECs, the EEC 240 may be associated with a globally unique value (e.g., EEC ID) that identifies the EEC 240. Further, reference to a single application client 235 and EEC 240 is merely provided for illustrative purposes, the UE 110 may be equipped with any appropriate number of application clients and EECs.

The edge data network 170 may also include an edge enabler server (EES) 174. The EES 174 may be configured to provide supporting functions to the EAS 172 and the EEC 240 running on the UE 110. For example, the EES 174 may perform operations related to concepts such as, but not limited to, provisioning configuration to enable the exchange of the application data traffic 305 between the UE 110 and the EAS 172 and providing information related to the EAS 172 to the EEC 235 running on the UE 110. Those skilled in the art will understand the variety of different types of operations and configurations relevant to an EES. Further, reference to the edge data network 170 including a single EAS 172 and a single EES 174 is merely provided for illustrative purposes. In an actual deployment scenario, an edge data network may include any appropriate EASs and EESs interacting with any number of UEs.

The ECS 180 may be configured to provide supporting functions for the EEC 240 to connect the EES 174. For example, the ECS 180 may perform operations related to concepts such as, but not limited to, provisioning of edge configuration information to the EEC 240. The edge configuration information may include the information for the EEC 240 to connect to the EES 174 (e.g., service area information, etc.) and the information for establishing a connection with the EES 174 (e.g., uniform resource identifier (URI). Those skilled in the art will understand the variety of different types of operations and configurations relevant to an ECS.

In the network architecture 100 and the enabling architecture 300, the ECS 180 is shown as being outside of the edge data network 170 and the core network 130. However, this is merely provided for illustrative purposes. The ECS 180 may be deployed in any appropriate virtual and/or physical location (e.g., within the mobile network operator's domain or within a third party domain) and implemented via any appropriate combination of hardware, software and/or firmware.

The interaction between the ECS 180 and the EEC 240 described above may occur prior to the flow of the application data traffic 305. However, as explained above, while the UE 110 is connected to the edge data network 170, the core network 130 may determine that the current path used for the application data traffic 305 should be switched. Various reasons for the path switch were described above. However, as also described above, the specific reason for the path switch is outside the scope of this disclosure as the exemplary embodiments may be applied to any reason for the core network 130 to determine that a path switch should occur. The exemplary embodiments relate to a relocation procedure between the UE 110 and the core network 130 when the core network 130 determines that a path switch should occur.

FIG. 4 shows a signaling diagram 400 for a relocation procedure according to various exemplary embodiments. The relocation procedure includes sending an indication to the UE 110 as to whether a new authentication with the ECS 180 is used when performing the relocation procedure. The signaling diagram 400 will be described with regard to the enabling architecture 300 of FIG. 3, the UE 110 of FIG. 2 and the network arrangement 100 of FIG. 1.

The signaling diagram 400 includes the UE 110, the SMF 133, a UL-CL1 401, a UL-CL2 402, a PSA1 403 and a PSA2 404. As described above, the UL-CL (e.g., UL-CL1 401, UL-CL2 402) and the PSA (e.g., PSA1 403 and a PSA2 404) are functions implemented by the UPF 134 of the core network 130. The UL-CL performs packet routing and forwarding to direct packet flows to specific data networks such as the edge data network 170. The PSA provides mobility for a UE PDU session.

Initially, the UE 110 may have a data path 410 set up between the UE 110 and the edge data network 170 using the UL-CL1 401 and the PSA1 403, e.g., the application data traffic 305 of FIG. 3. Thus, the initial portion of the signaling diagram 400 assumes that an authentication procedure has already taken place and the UE 110 is connected to the edge data network 170 via UL-CL1 401 and PSA1 403. However, during operation, the SMF 133 may determine that the path using UL-CL1 401 should be switched for any of a variety of reasons, examples of which were described above. Thus, in 420, the SMF 133, via an interaction with the UPF 134, may insert a new UL-CL (e.g., UL-CL2 402) and may keep or remove the old UL-CL1 401.

In 430, the SMF 133 sends a domain name system (DNS) re-resolution indication to UE 110 via a PDU Session Modification Command. In the exemplary embodiments, the PDU Session Modification Command includes an indication as to whether a new authorization and authentication procedure is used as part of the path switch. In some exemplary embodiments, the indication is an information element (IE), e.g., an authorization policy IE. However, other types of indications may be inserted into the PDU Session Modification Command to indicate the authorization and authentication procedure information. The indication may be associated with an area information which is indicated by the Internet Protocol (IP) segment, subnet info, a list of fully qualified domain names (FQDNs) or DNS suffixes, etc. This information is provided so that the UE 110 understands to which application the indication pertains. As described above, the UE 110 may be executing multiple application clients 235 that access multiple edge data networks 170. Thus, the authorization policy IE should include information such as described above so the UE 110 understands which application is subject to the path switch.

In some exemplary embodiments, the authorization policy IE may be a Boolean value, e.g., true or false, 0 or 1, etc. For example, if the authorization policy IE is set to “true”, the UE 110 may initiate the authorization/authentication procedure as will be described in greater detail below. If the authorization policy IE is set to “false”, the UE 110 may not initiate the authorization/authentication procedure as described below.

In other exemplary embodiments, the authorization policy IE may include more than 2 values. For example, if the authorization policy IE is set to “required”, the UE 110 may initiate the authorization/authentication procedure as will be described in greater detail below. If the authorization policy IE is set to “preferred/null”, the UE 110 may initiate the authorization/authentication procedure as will be described in greater detail below according to a security policy stored on the UE 110. If the authorization policy IE is set to “not needed”, the UE 110 may shall not initiate the authorization/authentication procedure as will be described in greater detail below.

It should be understood that the above values for the authorization policy IE are only exemplary and that other values may be defined to instruct the UE 110 to perform specific operations when the relocation procedure is being performed. In addition, the authorization policy IE may be any type of format such that the UE 110 and the SMF 133 understand the information being conveyed by the authorization policy IE. Moreover, the values of the authorization policy IE (e.g., whether the authorization/authentication procedure should be used) may be configured locally at the SMF 133 or may be sent to the SMF 133 from another function of the core network 130, e.g., an application function (AF).

In 440, the UE 110 may remove or replace the DNS records stored locally with the new DNS record. For example, if the area information is included in the DNS re-resolution indication 430, the UE 110 may only remove or replace the DNS records corresponding to that area information. The active connection between the UE 110 and the EAS 172 is not impacted. This operation triggers the UE 110 to reselect a new EAS 172 when the UE 110 initiates a new connection with a new EAS 172 as described below.

In 450, the UE 110 may determine whether to initiate the authorization/authentication procedure based on the information included in the authorization policy IE. As described above, the authorization policy IE may be set to “true” or “required”. In this situation, when the UE 110 performs the discovery 460, the discovery 460 will include a new authorization/authentication procedure to connect to the new EAS 172.

When the authorization policy IE is set to “preferred/null”, the UE 110 may refer to an internal/local security policy, e.g., stored in the memory arrangement 210, to determine whether the UE 110 should perform the authorization/authentication procedure as part of the discovery 460.

When the authorization policy IE is set to “false” or “not needed”, the UE 110 may operate in one of at least two different manners. In a first example, the UE 110 may perform the discovery 460 without performing the authorization/authentication procedure, e.g., the initial authorization/authentication procedure performed during the data path 410 set up is sufficient for the new path. In a second example, the UE 110 may stop the relocation procedure, e.g., the UE 110 does not perform the discovery 460 and the PDU session is dropped. These two examples may also apply to the “preferred/null” setting when the UE 110 does not have an internal/local security policy indicating that the authorization/authentication procedure should be performed.

In 460, the UE 110 discovers a new EAS 172 using the UL-CL2 402 and the PSA 2 404. This discovery procedure is similar to the discovery procedure used to initially set up the data path 410 with the exception of the authorization/authentication procedure being performed based on the information included in the authorization policy IE. If UL-CL2 402 was not inserted in 420, the new UL-CL2 402 may be inserted during the discovery operation 460.

Upon successful completion of the discovery 460, the UE 110 connects to the new EAS 172 located in the edge computing network 170 via the UL-CL2 402 and PSA2 404. This results in a new data path 480 between the UE 110 and the new EAS 172.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
connecting to a first edge application server (EAS) of an edge data network (EDN), the connecting comprising performing a first authorization/authentication procedure;
receiving a message indicating the UE is to connect to a second EAS of the EDN, the message including an indication as to whether the UE is to perform a second authorization/authentication procedure to connect to the second EAS; and
performing a discovery procedure to locate the second EAS based on at least the indication in the message.

2. The processor of claim 1, wherein the indication indicates the UE is to perform the second authorization/authentication procedure and wherein the discovery procedure includes performing the second authorization/authentication procedure.

3. The processor of claim 1, wherein the indication indicates the UE is not required to perform the second authorization/authentication procedure and wherein the discovery procedure does not include performing the second authorization/authentication procedure.

4. The processor of claim 1, wherein the indication comprises an authorization policy information element (IE).

5. The processor of claim 4, wherein the IE is set to a value of “true” indicating the UE is to perform the second authorization/authentication procedure or “false” indicating the UE is not to perform the second authorization/authentication procedure.

6. The processor of claim 4, wherein the IE is set to a value of one of (a) “required” indicating the UE is to perform the second authorization/authentication procedure, (b) or “not needed” indicating the UE is not to perform the second authorization/authentication procedure, or (c) “preferred/null” indicating the UE determines whether to perform the second authorization/authentication procedure based on a security policy stored in the UE.

7. The processor of claim 1, wherein the operations further comprise connecting the second EAS.

8. A processor of a network component configured to perform operations comprising:
determining that a connection between a user equipment (UE) and a first edge application server (EAS) of an edge data network (EDN) should be switched to a connection between the UE and a second EAS of the EDN; and
sending a message to the UE indicating the UE is to connect to the second EAS, the message including an indication as to whether the UE is to perform a second authorization/authentication procedure to connect to the second EAS.

9. The processor of claim 8, wherein the message comprises a PDU Session Modification Command.

10. The processor of claim 8, wherein the indication comprises an authorization policy information element (IE).

11. The processor of claim 8, wherein the indication indicates the UE is to perform the second authorization/authentication procedure.

12. The processor of claim 8, wherein the indication indicates the UE is not required to perform the second authorization/authentication procedure.

13. The processor of claim 8, wherein the indication indicates the UE is to determine whether to perform the second authorization/authentication procedure based on a security policy stored in the UE.

14. The processor of claim 8, wherein the operations further comprise:
replacing a first Uplink Classifier (UL-CL) associated with the first EAS with a second UL-CL associated with the second EAS.

15. A user equipment (UE), comprising:
a transceiver configured to connect to a network; and
a processor communicatively coupled to the transceiver and configured to perform operations comprising:
connecting to a first edge application server (EAS) of an edge data network (EDN), the connecting comprising performing a first authorization/authentication procedure;
receiving a message indicating the UE is to connect to a second EAS of the EDN, the message including an indication as to whether the UE is to perform a second authorization/authentication procedure to connect to the second EAS; and
performing a discovery procedure to locate the second EAS based on at least the indication in the message.

16. The UE of claim 15, wherein the indication indicates one of (a) the UE is to perform the second authorization/authentication procedure and wherein the discovery procedure includes performing the second authorization/authentication procedure or (b) the UE is not required to perform the second authorization/authentication procedure and wherein the discovery procedure does not include performing the second authorization/authentication procedure.

17. The UE of claim 15, wherein the indication comprises an authorization policy information element (IE).

18. The UE of claim 17, wherein the IE is set to a first value indicating the UE is to perform the second authorization/authentication procedure or a second value indicating the UE is not to perform the second authorization/authentication procedure.

19. The UE of claim 17, wherein the IE is set to one of (a) a first value indicating the UE is to perform the second authorization/authentication procedure, (b) a second value indicating the UE is not to perform the second authorization/authentication procedure, or (c) a third value indicating the UE determines whether to perform the second authorization/authentication procedure based on a security policy stored in the UE.

20. The UE of claim 15, wherein the operations further comprise connecting the second EAS.
